(19) United States
(12) Patent Application Publication
(10) Pub. No.: US 2013/0232028 A1
(43) Pub. Date: Sep. 5, 2013

(54) UTILIZING EMPTY SHIPPING CONTAINER SPACE AS A SELLING OPPORTUNITY

(71) Applicant: INTERNATIONAL BUSINESS MACHINES CORPORATION, Armonk, NY (US)

(72) Inventor: Robert J. Spremulli, Nashua, NH (US)

(73) Assignee: International Business Machines Corporation, Armonk, NY (US)

(21) Appl. No.: 13/859,136

(22) Filed: Apr. 9, 2013

Related U.S. Application Data
(63) Continuation of application No. 13/342,160, filed on Jan. 2, 2012.

(51) Int. Cl. G06Q 10/08

(52) U.S. Cl. CPC G06Q 10/083
USPC 705/26.7

(57) ABSTRACT

Embodiments of the invention may provide the ability to leverage product dimensions and weight to offer promotional items that will fit in the box that is already required to ship customer-selected items.

### CROSS-REFERENCE TO RELATED APPLICATIONS

This application is a continuation of and claims priority to U.S. patent application Ser. No. 13/342,160, filed Jan. 2, 2012, the contents of which is incorporated herein by reference in its entirety.

### BACKGROUND

The present invention relates to data processing, and more particularly to systems, methods, and computer program products for utilizing empty shipping container space. When consumers make purchases online, many websites use promotional engines in order to offer additional products and services to the consumer. This list of goods may be derived from many sources, including the customer's previously browsed items, items commonly purchased together, or items that will make the order eligible for some promotion, such as free shipping. Separately, a common occurrence on consumer advocacy and information sites is open mockery when items ordered are shipped in excessive packaging. Some companies in particular are ridiculed due to the frequency with which it happens. This potentially turns a shipping mistake into a marketing and public relations problem.

### BRIEF SUMMARY

In one embodiment of the invention, a computer-implemented method for utilizing empty shipping container space comprises receiving a customer selection of one or more items to be shipped; determining dimensions of the one or more items to be shipped; identifying, in dependence on the determined dimensions, a shipping container to be utilized to ship the one or more items; determining remaining space that will be available within the shipping container along with the one or more items packed in the shipping container; determining one or more additional items which will fit within the available remaining space; and displaying at least one of the one or more additional items to the customer for purchase.

In addition to the method for utilizing empty shipping container space, as described above, other aspects of the present invention are directed to corresponding systems and computer program products for utilizing empty shipping container space.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A-C is a flowchart of a method of utilizing empty shipping container space, in accordance with an embodiment of the present invention;

FIG. 2 illustrates an example of determining one or more packable spaces, in accordance with embodiments of the present invention;

FIG. 3 is a schematic block diagram of a computer network in which embodiments of the present invention may operate; and

FIG. 4 is a schematic block diagram of a computer in the network of FIG. 3.

### DETAILED DESCRIPTION

Embodiments of the invention may provide the ability to leverage product dimensions and weight to offer promotional items that will fit in the box that is already required to ship customer-selected items. Such an effort to entice a customer to add additional items to an order is often termed “upselling.”

Order management systems (such as may be provided by an online store, which typically provides many different products for sale to a customer) can leverage knowledge of size, weight, and containerization of the products being ordered to offer additional products that will fit in the remaining space in the shipping container. The additional items offered for sale to the customer are determined by filtering a list of items that are available for ordering. The list of items that are available for ordering (which is then filtered to determine which item(s) can fit in the remaining space in the shipping container and may be offered to the customer) could simply be a list of every item offered for sale by the online store. Alternatively, the list that is filtered by embodiments of the invention may comprise a subset of all the items offered for sale by the online store. For example, the subset could include only promotional items. Such additional items may be promotionally offered to the customer using a displayed statement such as “Fits right in the box we've already packed for you!” Such additional items may be further incentivized by offering free or reduced-cost shipping.

Such upselling may be successful with consumers who are environmentally conscious as it has the potential to reduce packing filler, is a conscious effort to control excessive package size, and may be viewed as an effort to repair previously damaged public relations.

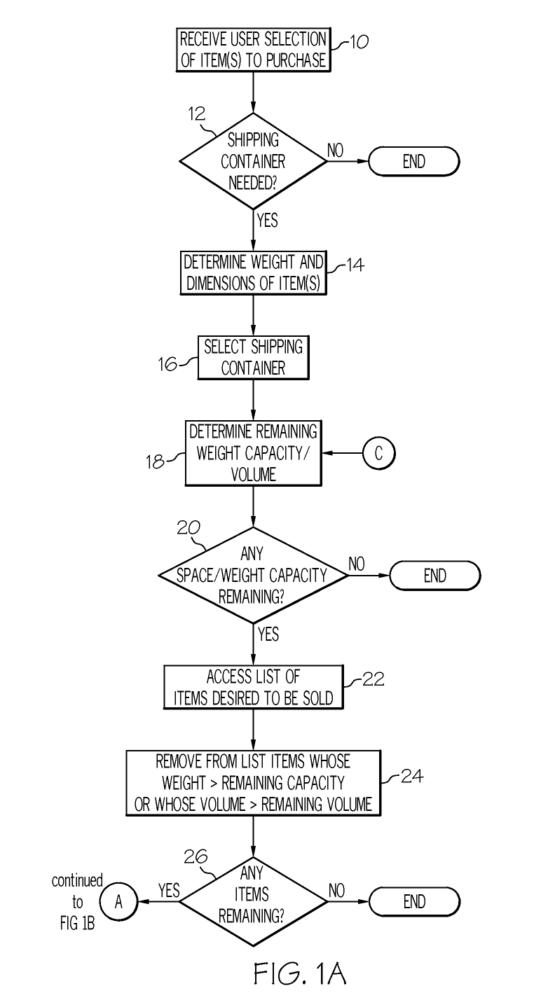

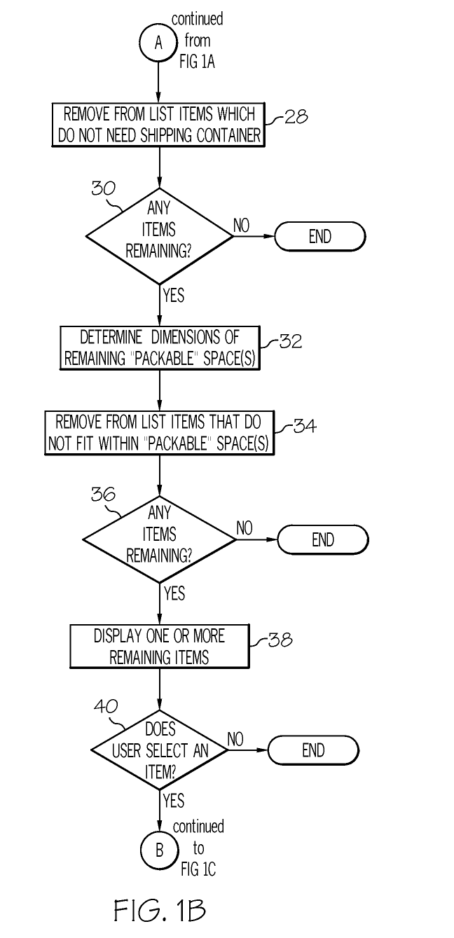

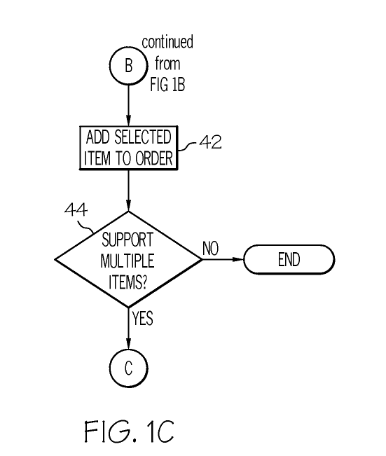

Referring now to FIGS. 1A-C, a flowchart of a method of utilizing empty shipping container space is illustrated in accordance with an embodiment of the present invention. The process of embodiments of the invention typically begins after a customer selects one or more items to order, such as by clicking a button in an online store to place the one or more items into a virtual “shopping cart,” and commences a “check out” routine. The method, system, or computer program product of embodiments of the invention receives the customer selection of one or more items (block 10). It is determined whether a shipping container is needed to ship the selected item(s) (block 12) (as compared to shipping the item(s) in its/their factory-provided packaging with no additional “overpack”). If no shipping container is needed, then no upsell opportunity exists (there is no extra space in the shipping container because there is no shipping container) and the process ends. If a shipping container is needed, the weight and dimensions (length, width, height for a rectangular item) of the selected item(s) is determined (block 14). The weight and dimensions of each item in the online store will typically be stored in a product database. The appropriate shipping container is selected that will hold the selected item(s) for shipping (block 16). The shipping container selection is typically based on the dimensions and weight of the selected items. The order management system will typically store in a database the manufacturer-specified weight capacity and dimensions/volume of each type of shipping container that may be used.

Based on the selected shipping container and the dimensions and weight of the selected item(s), any remaining weight and/or volume capacity may be determined (block 18). The remaining weight capacity is typically determined by comparing the manufacturer-specified weight capacity of the selected shipping container to the weight of the selected item (or the sum of the weights of multiple items). The remaining volume capacity is typically determined by comparing the volume of the selected shipping container to the volume of the selected item (or the sum of the volumes of multiple items). This determined remaining volume capacity does not take into consideration the effectiveness or usability of the space; rather, it is simply a determination of the “raw” volume capacity remaining As will be discussed in more detail below, it may be desirable to further determine the “packable space(s)” remaining, which provides a more accurate picture of which additional item(s) may fit in the remaining space.

Based on the determinations at block 18, it is determined if there will be any space and weight capacity remaining in the shipping container along with the selected item(s) is/are placed in the shipping container (block 20). The determination at block 20 could simply determine if there will be any space and weight capacity remaining at all in the shipping container, regardless of how little space or weight capacity remains. That is, as long as the remaining space or weight capacity is greater than zero, the result at block 20 would be “YES.” However, space or weight capacity remaining that, while greater than zero, is very close to zero is less likely to result in any additional items being offered to the customer, unless the online store sells very small/light items. Thus, it may be desirable to use a cutoff other than zero at block 20. Such a cutoff may be expressed as a number (e.g., weight in pounds/kilograms and volume in cubic inches/centimeters), as a percentage of the total weight/volume capacity, or as both (e.g., a number for weight and a percentage for volume, or vice versa). For example, it may be desirable to use a cutoff of 0.5 pounds for weight and 10% for volume. In such an example, it would be determined at block 20 that there is capacity remaining only if the remaining weight capacity at least 0.5 pounds and if the remaining volume is at least 10% of the total volume of the shipping container. Any combination of types of cutoffs (zero, number, percentage) and cutoff values may be used for the weight and volume cutoffs. The determination at block 20 might also take into account any packing materials that may need to be used to protect/cushion the selected item(s) and which would likely also consume space in the shipping container. For example, a selected item may be fragile and therefore may need to be wrapped in bubble wrap. Embodiments of the invention may determine if such packing material is needed and, if so, what type of packing material. Based on the type of packing material to be used, embodiments of the invention may then determine by how much the packing material will increase the volume of the corresponding selected item and use that increased volume as the volume of the selected item for determining if any space is remaining in the shipping container.

Note, it must be determined that there is both space remaining and weight capacity remaining in order to be able to offer any additional items to the customer. Having only space remaining without having weight capacity remaining, or conversely having only weight capacity remaining without having space remaining, would prevent any additional items from being shipped in the same shipping container.

If it is determined at block 20 that there is no weight capacity remaining or that there is not volume remaining, the process ends and no additional items are offered to the customer. If it is determined at block 20 that there is weight and volume capacity remaining, a list of items desired to be sold is accessed (block 22). This list may comprise all items for sale in the online store, or may comprise a subset of all items for sale. For example, this list may comprise a predetermined list of promotional items (i.e., items that the online store wants to promote the sale of more than usual or more than other items). From this list, each item whose weight is greater than the determined remaining weight capacity of the shipping container is removed, and each item whose volume is greater than the determined remaining volume of the shipping container is removed (block 24).

After removing the items at block 24, it is determined if any items remain in the list (block 26). If it is determined at block 26 that no items remain in the list after removing each item whose weight is greater than the determined remaining weight capacity and each item whose volume is greater than the determined remaining volume, the process ends and no additional items are offered to the customer. If it is determined at block 26 that items remain in the list, items in the remaining list that do not require a shipping container are removed from the remaining list (block 28).

After removing the items at block 28, it is determined if any items remain in the list (block 30). If it is determined at block 30 that no items remain in the list after removing each item which does not require a shipping container, the process ends and no additional items are offered to the customer. If it is determined at block 30 that items remain in the list, the dimensions of any remaining “packable” space(s) is/are determined (block 32).

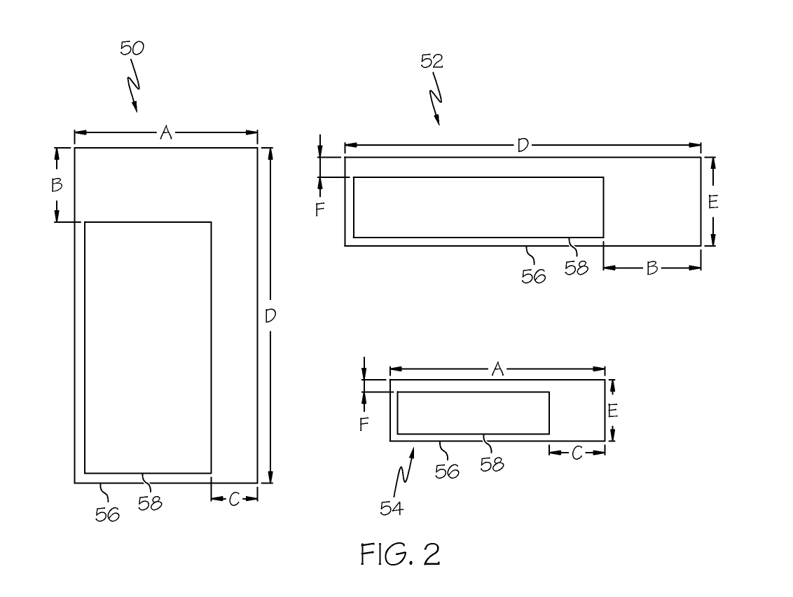

The packable spaces represent spaces within the remaining volume capacity into which additional items may be effectively placed. It should be appreciated that simply determining total remaining volume capacity provides an incomplete and in some respects misleading picture of which additional items may also be shipped in the shipping container. This is because it is not only the total remaining volume but also the shape and configuration of the remaining spaces that determines which additional items may also be shipped. The concept of packable spaces is illustrated in FIG. 2. FIG. 2 illustrates a top view 50, a side view 52 and an end view 54 of an item 58 to be shipped within a shipping container 56. While FIG. 2 illustrates small spaces between item 58 and the inner wall of the shipping container 56 (i.e., to the left of and below item 58 in the top view; to the right of and below item 58 in the side view; to the right of and below item 58 in the end view), these small spaces would not typically exist in a real world situation because item 58 would be placed tightly against the inner walls of the shipping container to maximize, if necessary, the size of the packable spaces. Thus, these small spaces are only included in FIG. 2 to clearly differentiate the sides of the item 58 from the sides of the shipping container 56. The packable spaces in FIG. 2 are to the right of and above item 58 in the top view, to the right of and above item 58 in the side view, and to the right of and above item 58 in the end view. There are three discrete parallelepiped packable spaces in FIG. 2. One packable space measures A×B×E; another packable space measures C×D×E; and the third packable space measures A×D×F.

Returning to FIG. 1, after the dimensions of the remaining packable space(s) is/are determined at block 32, items in the remaining list that do not fit within any of the packable spaces are removed from the remaining list (block 34). For items having a parallelepiped shape, such items will fit within a packable space if each dimension of an item is smaller than a corresponding dimension of one of the one or more packable spaces. For example, consider the packable space in FIG. 2 which measures A×B×E, with A being the largest dimension, B being the middle size dimension, and E being the smallest dimension. An item will fit within the A×B×E packable space if (i) the largest dimension of the item is less than A; (ii) if the middle size dimension of the item is less than B; and if the smallest dimension of the item is less than E. Note that each of the three dimensions of the item must be smaller than the corresponding dimension of the packable space for the item to fit within the packable space; if any dimension of the item is larger than the corresponding dimension of the packable space then the item will not fit within the packable space. Alternatively, such items may be considered to fit within a packable space if each dimension of an item is smaller than or equal to a corresponding dimension of one of the one or more packable spaces, although such an alternative embodiment may result in the items fitting too tightly within the shipping container. Further alternatively, an item may need to be a specified amount or percentage smaller than a packable space to be considered to fit with the packable space. In such a further alternative, an item may be considered to fit within a packable space if each dimension of the item is at least X inches/centimeters (e.g., 0.25 inches) smaller or least Y% (e.g., 5%) smaller than a corresponding dimension of one of the one or more packable spaces.

For items having other than a parallelepiped shape (e.g., cylindrical, oval, spherical, etc.), other techniques may be used to determine if such an item will fit within a packable space. One technique may be to determine the dimensions of an equivalent parallelepiped into which the non-parallelepiped-shaped item would fit, and then to determine if the equivalent parallelepiped fits within the packable space. For example, for a round cylindrical item having a height of A and a diameter of B, the equivalent parallelepiped would measure A×B×B. For an oval cylindrical item having a height of A, a long dimension of B, and a short dimension of C, the equivalent parallelepiped would measure A×B×C. For a spherical item having a diameter of A, the equivalent parallelepiped would measure A×A×A.

After removing the items at block 34, it is determined if any items remain in the list (block 36). If it is determined at block 36 that no items remain in the list after removing all items which do not fit within any of the packable spaces, the process ends and no additional items are offered to the customer. If it is determined at block 36 that items remain in the list, one or more of the items remaining in the list are displayed to the customer (block 38). Which and how many of the remaining items in the list are displayed may vary, based on, e.g., known upselling techniques.

If the customer does not select any of the additional items that are displayed (as determined at block 40), then the process ends and the check-out process continues as usual. If the customer selects one of the displayed additional items, the selected additional item is added to the order (block 42). The order management system may or may not be configured to support upselling multiple items. If the order management system does not support upselling multiple items (block 44), then the process ends and the check-out process continues as usual with the one additional item that was selected being included in the order. If the order management system does support upselling multiple items (block 44), then the process returns to block 18 to re-determine the remaining weight capacity/volume after the selected additional item has been added to the order and the process continues from block 18.

The filters applied in the embodiment of the invention illustrated in FIG. 1 (block 24, block 28, block 34) may generally be applied in any order, although it may be desirable to apply the filters in order of how computationally intensive each filter is (e.g., the least computationally intensive filter is applied first and the most computationally intensive filter is applied last).

Additionally, some of the filters may be omitted entirely, although this may increase the computational requirements of the process. For example, block 18 may be modified to only determine remaining weight capacity (and not volume), and the filter at block 24 may be modified to only check against remaining weight capacity. These modifications are possible because the volume filter at block 24 is only a preliminary filter, and the packable space filter at block 34 is the main determinant of whether an additional item will fit within the shipping container. While the packable space filter at block 34 may be more computationally intensive than the preliminary volume filter at block 24, the preliminary volume filter at block 24 may be omitted if sufficient computational capacity is available such that the packable space filter at block 34 can be performed on as many items as necessary in an imperceptibly small amount of time so as to not slow the ordering process.

Additional filters not illustrated in FIG. 1 may optionally be added to the process. For example, an additional filter could remove any items from the list which do not fit within the selected shipping container, even if the shipping container were empty. Such an optional filter would likely be applied early on in the process.

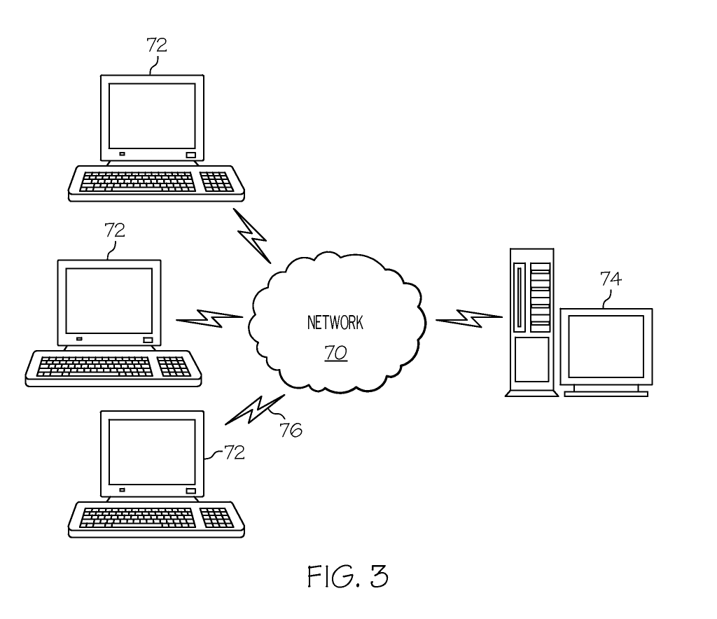

FIG. 3 is a schematic block diagram of a computer network in which embodiments of the present invention may operate. Computers 72 and server 74 provide processing, storage, and input/output devices executing application programs and the like. Computers 72 may be linked over communication link 76 through communications network 70 to each other and to other computing devices, including servers 74. Communications network 70 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. However, computers 72 and servers 74 may be linked over any suitable communication network. In the system of FIG. 3, an order management system (e.g., online store) implementing an embodiment of the invention could reside on server 74 and receive orders from customers using computers 72.

In addition to the client-server arrangement of FIG. 3, embodiments of the invention may operate in any client-server arrangement or in any networked arrangement in which resources that originate communications and resources that receive communications may reside on separate elements in a network. For example, embodiments of the invention may operate in a mobile communications/data architecture (such as a mobile telecommunications network adhering to the International Mobile Telecommunications-2000 (also termed 3G) or IMT-Advanced (also termed 4G) standards), in which a mobile telecommunications device (e.g., cell/mobile telephone) communicates.

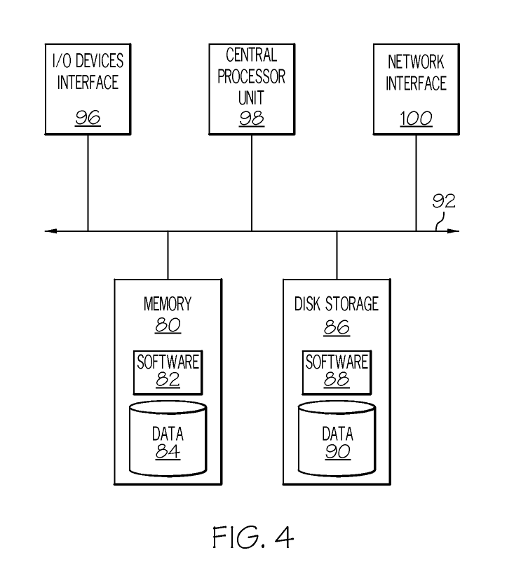

FIG. 4 is a diagram of one possible internal structure of a computer (e.g., computer 72) or server in the system of FIG. 3. Each computer typically contains system bus 92, where a bus is a set of hardware lines used for data transfer among the components of a computer. Bus 92 is essentially a shared conduit that connects different elements of a computer system (e.g., processor, disk storage, memory, input/output ports, network ports, etc.) that enables the transfer of information between the elements. Attached to system bus 92 is I/O device interface 96 for connecting various input and output devices (e.g., displays, printers, speakers, microphones, etc.) to the computer. Alternatively, the I/O devices may be connected via one or more I/O processors attached to system bus 92. Network interface 100 allows the computer to connect to various other devices attached to a network (e.g., network 70 of FIG. 3). Memory 80 provides volatile storage for computer software instructions 82 and data 84 used to implement an embodiment of the present invention. Disk storage 86 provides non-volatile storage for computer software instructions 88 and data 90 used to implement an embodiment of the present invention. Central processor unit 98 is also attached to system bus 92 and provides for the execution of computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. If the service is also available to applications as a REST interface, then launching applications could use a scripting language like JavaScript to access the REST interface. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the FIG.s illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIG.s. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A computer-implemented method for utilizing empty shipping container space, comprising:
receiving, by a computer, a customer selection of one or more items to be shipped;
determining, by the computer, dimensions of the one or more items to be shipped;
identifying, by the computer in dependence on the determined dimensions, a shipping container to be utilized to ship the one or more items;
determining, by the computer, remaining space that will be available within the shipping container along with the one or more items packed in the shipping container;
determining, by the computer, one or more additional items which will fit within the available remaining space; and
displaying, by the computer, at least one of the one or more additional items to the customer for purchase.

2. The method of claim 1, further comprising:
accessing, by the computer, a list of items desired to be sold;
wherein the one or more additional items are determined from the list of items desired to be sold.

3. The method of claim 1, further comprising:
determining, by the computer, a weight of the one or more items to be shipped; and
determining, by the computer, which one or more additional items can be shipped in the shipping container with the one or more items to be shipped without exceeding a weight limit of the shipping container.

4. The method of claim 1, wherein determining remaining space that will be available within the shipping container along with the one or more items packed in the shipping container comprises determining dimensions of one or more packable spaces that will be available within the shipping container along with the one or more items packed in the shipping container.

5. The method of claim 4, wherein determining one or more additional items which will fit within the available remaining space comprises determining one or more additional items which will fit within at least one of the one or more packable spaces.

6. The method of claim 5, wherein determining one or more additional items which will fit within at least one of the one or more packable spaces comprises determining one or more additional items for which each dimension is smaller than a corresponding dimension of one of the one or more packable spaces.
